(19) United States
(12) Patent Application Publication
(10) Pub. No.: US 2019/0265101 A1
(43) Pub. Date: Aug. 29, 2019

(54) PHOTOMETER

(71) Applicant: SHIMADZU CORPORATION, Kyoto-shi, Kyoto (JP)

(72) Inventors: Hiroyuki TOGO, Kyoto-shi (JP); Shinji TSUJI, Kyoto-shi (JP)

(73) Assignee: SHIMADZU CORPORATION, Kyoto-shi, Kyoto (JP)

(21) Appl. No.: 16/310,563

(22) PCT Filed: Jul. 25, 2016
(86) PCT No.: PCT/JP2016/071679

§ 371 Date: Dec. 17, 2018

(51) Int. Cl. G01J 3/02; G01N 21/01; G01J 3/10; G03B 21/20

(52) U.S. Cl. CPC G01J 3/0202; G03B 21/2066; G01J 3/10; G01N 21/01

(57) ABSTRACT

A photometer (100), which includes a light source (1), an optical element (30) disposed on an optical path P of light emitted from the light source (1), and a detector (5), includes: an attenuating filter (24a) that is disposed on the optical path P and between the light source (1) and the optical element (30), and blocks a portion of the light emitted from the light source (1) and allows the rest of the light to be transmitted through the attenuating filter (24a); and a state monitoring unit (83) that monitors whether or not the light source (1) and the optical element (30) are in a stable state by monitoring light that has been transmitted through the attenuating filter (24a) on the side of a stage subsequent to the optical element (30).

### TECHNICAL FIELD

The present invention relates to a photometer that measures the transmittance, reflectance, or absorbance, etc. of a sample by exposing the sample to light from a light source and detecting its transmitted light or reflected light.

### BACKGROUND ART

In a spectrophotometer that is a kind of photometer, a spectrometer, a sample (or a sample cell through which a liquid/gas sample flows), and a detector are set on an optical path of light emitted from a light source (source light). The spectrophotometer identifies the transmittance, reflectance, absorbance, etc. of the sample by detecting light transmitted through the sample (or light reflected by the sample) after the light has been emitted from the light source and spectrally separated by the spectrometer. The spectrometer may be set on the subsequent stage side of the sample to spectrally separate light that has been transmitted through the sample (or light that has been reflected by the sample).

In a spectrophotometer, a deuterium lamp, a halogen lamp, or the like is often used as a light source. However, the light source is unstable in the amount of light for a while after being turned on, and becomes stable in the amount of light after a lapse of at least about one hour. Therefore, in a spectrophotometer, once a device is powered on, a light source is often kept turned on until it is powered off. That is, unless the device is powered off, the light source will not be turned off even after a measurement is completed, and will be kept turned on even in a period of time between measurements (a period of time in which the device is in a standby state).

Normally, in a spectrophotometer, not only a sample and a detector but also various optical elements such as a mirror, a lens, and a spectral element are set on an optical path of source light. These optical elements are normally deteriorated gradually by exposure to light. For example, if a mirror including glass coated with aluminum continues to be exposed to light (particularly, ultraviolet light), the mirror gradually becomes dim, which leads to a decrease in reflectance. In a spectrophotometer, deterioration of optical elements cause noise in measurement, and therefore the optical elements need to be replaced periodically.

A replacement life of each optical element depends on the magnitude of light energy that the optical element receives and the length of time in which the optical element is exposed to light. For example, in a case where a deuterium lamp of high-intensity ultraviolet light is used as a light source in a spectrophotometer, light energy that an optical element receives is high, and therefore, a replacement life of the optical element becomes notably short. In addition, in the spectrophotometer, as described above, the light source is kept turned on even in a period of a standby state in which any measurement is not being carried out, and therefore, deterioration of the optical element progresses wastefully.

Accordingly, for example, Patent Literature 1 proposes a configuration in which a shutter is provided between a light source and a sample cell so that while any measurement is not being carried out, the shutter blocks source light to prevent the light from entering the sample cell and a subsequent optical element. According to this configuration, wasteful deterioration of an optical element is prevented.

### CITATION LIST

### Patent Literature

Patent Literature 1: WO 2013/140617 A

### SUMMARY OF INVENTION

### Technical Problem

As described above, a light source of a spectrophotometer is unstable in the amount of light for a while after being turned on, and until the amount of light becomes stable, measurement data cannot be obtained. Furthermore, for a while after the light source is turned on, heat generated by the light source increases the temperature of an internal space of the spectrophotometer, and during this temperature change, an optical element and a member that supports the optical element undergo infinitesimal deformation, and the optical element is moved. This causes an optical path of source light to deviate from an intended position, and therefore, an intended amount of light does not reach a detector. Also in such a state, reliable measurement data cannot be obtained.

In the configuration of Patent Literature 1, while the shutter is placed on an optical path, no source light reaches an optical element, a detector, etc. that are located on the subsequent stage side of the shutter. Therefore, during this time, there are no means of grasping respective states of a light source and the optical element. Accordingly, after an instruction to start a measurement has been issued from a user, and the shutter has been removed from the optical path in accordance with the instruction, whether or not the light source and the optical element are in a stable state (i.e., whether or not the spectrophotometer is in a fit state to obtain reliable measurement data) is confirmed, for example, from the transition of the amount of light that has reached the detector through the optical element, and after this confirmation, the measurement is started.

However, according to this method, there is a time lag between when an instruction to start a measurement has been issued from a user and when the measurement is actually started.

Such a situation is not limited to a spectrophotometer, and also applies to various photometers that do not include a spectrometer.

The present invention has been made in view of such problems, and an object of the invention is to provide a technique that can suppress wasteful deterioration of an optical element without causing a delay in starting a measurement.

### Solution to Problem

The present invention made for solving the above-described problems is a photometer, which includes a light source, an optical element disposed on an optical path of light emitted from the light source, and a detector, includes:

an attenuating filter that is disposed on the optical path and between the light source and the optical element, and blocks a portion of the light emitted from the light source and allows a rest of the light to be transmitted through the attenuating filter; and

a state monitoring unit that monitors whether or not the light source and the optical element are in a stable state by monitoring light that has been transmitted through the attenuating filter on the side of a stage subsequent to the optical element.

According to this configuration, a portion of the light emitted from the light source is blocked, and therefore, wasteful deterioration of the optical element disposed on the optical path of the light is suppressed. Furthermore, a portion of the light emitted from the light source is transmitted through the attenuating filter without being blocked by the attenuating filter, and whether or not the light source and the optical element are in a stable state is monitored by using the transmitted light; therefore, when an instruction to start a measurement from a user has been received, whether or not they are in a stable state (i.e., whether or not they are in a fit state to measure) is confirmed immediately. Therefore, there is no time lag between when the instruction to start a measurement has been issued from the user and when the measurement is actually started.

It is preferable that the photometer further includes a position changing unit that causes the attenuating filter to move between a position on the optical path of the light emitted from the light source and a position deviated from the optical path.

In this configuration, the position of the attenuating filter is changed, for example, in such a manner that in a standby state, the attenuating filter is set in the position on the optical path of the light emitted from the light source, and while a measurement is being carried out, the attenuating filter is set in the position deviated from the optical path. Therefore, it is possible to carry out a highly accurate measurement with a sufficient amount of light while suppressing wasteful deterioration of the optical element during a standby state.

It is preferable that the photometer further includes: a plurality of filters with different transmittances; and an attenuating filter selecting unit that sets, as the attenuating filter, one filter selected from the plurality of filters in the position on the optical path.

According to this configuration, the transmittance of the attenuating filter can be switched. The transmittance of the attenuating filter is switched, for example, in such a manner that in a standby state, a filter with a relatively low transmittance is selected as the attenuating filter and set in the position on the optical path, and while a measurement is being carried out, a filter with a relatively high transmittance is selected as the attenuating filter and set in the position on the optical path. Therefore, it is possible to carry out a highly accurate measurement with a sufficient amount of light while suppressing wasteful deterioration of the optical element during a standby state.

It is preferable that the state monitoring unit of the photometer monitors whether or not the light source and the optical element are in a stable state by monitoring the amount of light detected by the detector.

According to this configuration, the detector used for measurement of a sample is used to monitor the state of the device, and therefore, it is possible to reduce the number of components.

### Advantageous Effects of Invention

According to this invention, a portion of light emitted from the light source is blocked by the attenuating filter, and therefore, wasteful deterioration of the optical element set on the optical path of the light is suppressed. Meanwhile, a portion of the light emitted from the light source is transmitted through the attenuating filter without being blocked by the attenuating filter, and whether or not the light source and the optical element are in a stable state is monitored by using the transmitted light. Therefore, there is no time lag between when an instruction to start a measurement has been issued from a user and when the measurement is actually started. Accordingly, it is possible to suppress wasteful deterioration of the optical element without causing a delay in starting the measurement.

### BRIEF DESCRIPTION OF DRAWINGS

FIG. 1 is a block diagram showing a schematic configuration of a spectrophotometer according to an embodiment.

FIG. 2 is a diagram schematically showing a configuration of a shieling part.

FIG. 3 is a diagram showing a configuration example of a setting screen for setting the transmittance of the shieling part.

FIG. 4 is a diagram schematically showing a state of the spectrophotometer during standby.

FIG. 5 is a diagram schematically showing a state of the spectrophotometer at the time of measurement.

FIG. 6 is a diagram schematically showing another state of the spectrophotometer at the time of measurement.

FIG. 7 is a diagram showing a table of how a life of an optical element and noise at the time of measurement change depending on the transmittance of the shieling part.

FIG. 8 is a diagram showing an example of the transition of detection signals obtained from a detector.

FIG. 9 is a diagram for describing the flow of the operation of the spectrophotometer.

FIG. 10 is a diagram showing a configuration of a state monitoring unit according to a modification example.

### DESCRIPTION OF EMBODIMENTS

An embodiment of a photometer according to the present invention is described below with reference to the accompanying drawings. The embodiment described below is an embodied example of the invention, and does not limit the technical scope of the invention.

### 1. Overall Configuration of Spectrophotometer

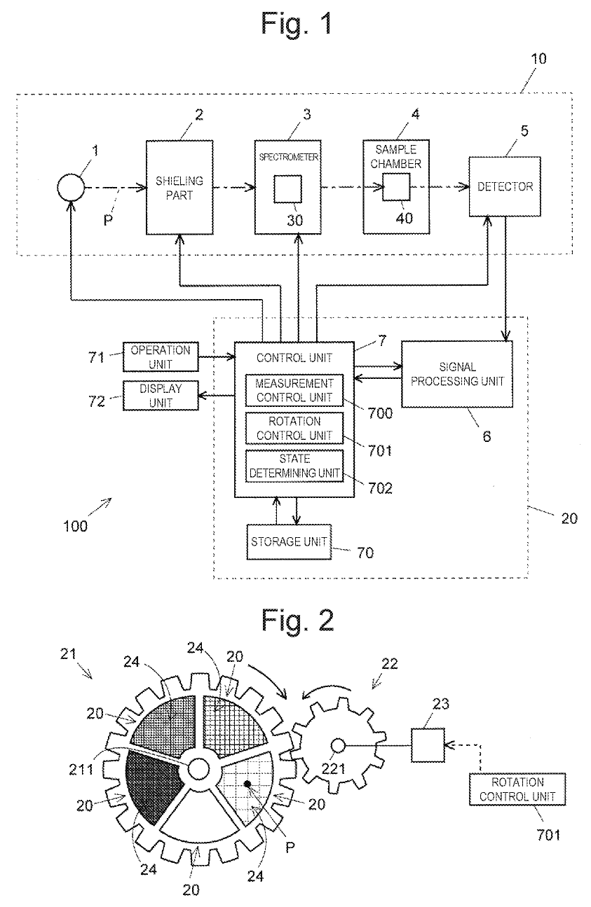

An overall configuration of a photometer (here, a spectrophotometer as an example) according to the embodiment is described with reference to FIG. 1. FIG. 1 is a block diagram showing a schematic configuration of a spectrophotometer 100.

The spectrophotometer 100 includes a photometer 10 and a controller/processor 11.

The photometer 10 includes a light source 1. The light source 1 includes, for example, a deuterium lamp.

A shieling part 2 is set on an optical path P of light emitted from the light source 1. The shieling part 2 is a component that blocks a portion of incident light and allows the rest of the incident light to be transmitted through it. A specific configuration of the shieling part 2 is described later.

A spectrometer 3 is set on the optical path P and in the subsequent stage of the shieling part 2. The spectrometer 3 is a device that selects and takes out one of wavelengths of the incident light as monochromatic light, and includes various optical elements (a mirror, a diffraction grating, etc.) 30.

Furthermore, a sample chamber 4 in which a sample cell 40 is housed and a detector are set on the optical path P and in the subsequent stage of the spectrometer 3 in this order. Various samples (liquid samples or gas samples) flow through the sample cell 40. The detector 5 includes, for example, one photodiode.

In the photometer 10 having the above configuration, when light source 1 has been turned on, light emitted from the light source 1 enters the spectrometer 3 through the shieling part 2, and monochromatic light is taken out in the spectrometer 3 and enters the sample cell 40. Then, light that has been transmitted through the sample cell 40 enters the detector 5.

The controller/processor 11 includes a signal processing unit 6 and a control unit 7. The signal processing unit 6 is electrically connected to the detector 5, and a detection signal of the detector 5 is input to the signal processing unit 6. The signal processing unit 6 processes the received detection signal, and performs various arithmetic processing (for example, arithmetic processing for identifying the amount of light that has reached the detector 5, arithmetic processing to calculate the transmittance, reflectance, or absorbance, etc. of a sample on the basis of the identified amount of light, etc.).

The control unit 7 is a component that controls the operations of the signal processing unit 6 and the photometer 10, and is connected to a storage unit 70 that stores various information necessary for the processing. Furthermore, the control unit 7 is connected to an operation unit 71 through which a user, for example, sets various parameters related to measurement and issues various instructions. Moreover, the control unit 7 is connected to a display unit 72 on which screens for receiving various settings and instructions from the user, auxiliary information for operation, a measurement result, etc. are displayed.

In the control unit 7, a measurement control unit 700, a rotation control unit 701, and a state determining unit 702 are implemented as a functional block. The measurement control unit 700 controls the operations of the signal processing unit 6 and the photometer 10, and causes these units to perform a predetermined process, thereby making a measurement of a sample. The functions of the rotation control unit 701 and the state determining unit 702 are revealed later.

The controller/processor 11 can be mainly composed of, specifically, for example, a general-purpose personal computer connected to the photometer 10. In this case, by installing a predetermined control program on the personal computer, the various functional blocks 700, 701, and 702 are implemented.

### 2. Shieling Member

The configuration of the shieling part 2 is described with reference to FIG. 2. FIG. 2 is a diagram schematically showing the configuration of the shieling part 2.

The shieling part 2 has a configuration in which a pair of gears (a first gear 21 and a second gear 22 smaller than the first gear 21) with teeth provided on their outer periphery are engaged with each other.

The first gear 21 is set between the light source 1 and the spectrometer 3 in a posture that allows an axle 211 to be parallel to an optical path P (i.e., an optical path P of light emitted from the light source 1).

The first gear 21 is provided with a plurality of (five, in an example of FIG. 2) window portions 20 around the axle 211, and the first gear 21 is set in a position that allows the optical path P to go through any of formation positions of the window portions 20.

Except one of them, the plurality of window portions 20 are provided with a filter 24 inside of them. Each filter 24 is a member that blocks a portion of incident light and allows the rest of the incident light to be transmitted through it, and is made of, for example, wire mesh. The transmittance of the filter 24 made of wire mesh depends on its mesh density; the higher the mesh density of wire mesh is, the lower the transmittance gets. Here, the respective filters 24 provided in the plurality of window portions 20 differ from one another in the transmittance (specifically, the mesh density).

The second gear 22 is set to be engaged with the first gear 21 in a posture that allows its axle 221 to be parallel to the axle 211 of the first gear 21. A drive unit 23, which rotates the second gear 22, is connected to the axle 221 of the second gear 22. The drive unit 23 includes, for example, a motor. The drive unit 23 is electrically connected to the rotation control unit 701, and the revolving speed, the revolving timing, etc. of the drive unit 23 are controlled by the rotation control unit 701.

The rotation control unit 701 controls the drive unit 23, and causes the drive unit 23 to rotate the second gear 22. When the second gear 22 is rotated, the first gear 21 rotates in accordance with the rotation of the second gear 22, and this sequentially switches the window portion 20 through which the optical path P to go.

For example, in the example of FIG. 2, when the first gear 21 rotates clockwise from a state shown in FIG. 2, the window portion 20 through which the optical path P to go is sequentially switched, and the filter 24 to be set in the position on the optical path P is sequentially switched. That is, the drive unit 23 and the rotation control unit 701 work together and serve as a filter selecting unit 81 (FIGS. 4 to 6) that sets one filter 24 selected from the multiple filters 24 with different transmittances in the position on the optical path P.

Furthermore, after a certain number of rotations of the first gear 21, the optical path P goes through the one window portion 20 provided with no filter. In other words, it goes into a state in which all the filters 24 are located in a position deviated from the optical path P. That is, the drive unit 23 and the rotation control unit 701 work together and serve as a position changing unit 82 (FIGS. 4 to 6) that causes the filters 24 to move between the position on the optical path P and the position deviated from the optical path P.

The rotation control unit 701 determines what timing and which of the filters 24 is to be set in the position on the optical path P (or whether all the filters 24 are to be deviated from the position on the optical path P) on the basis of an instruction from the user.

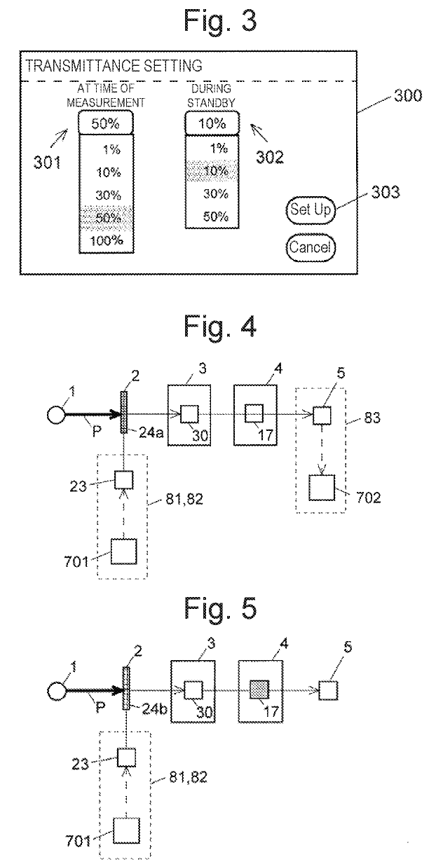

In regard to this determination, the rotation control unit 701 causes a setting screen 300 for the user to set the respective transmittances of the shieling part 2 at the time of measurement and during standby to be displayed on the display unit 72. FIG. 3 shows a configuration example of the setting screen 300. As shown in FIG. 3, a first entry field 301 and a second entry field 302 are displayed on the setting screen 300. The first entry field 301 is for setting the transmittance of the shieling part 2 in a period of time in which a measurement is carried out (at the time of measurement), and the second entry field 302 is for setting the transmittance of the shieling part 2 in a period of time in which the spectrophotometer 100 has been powered on and any measurement is not being carried out (during standby).

In the first entry field 301, a list of selectable values as the transmittance of the shieling part 2 at the time of measurement is displayed, for example, in the form of a pull-down menu. The selectable transmittances here are specifically respective transmittances of the multiple filters 24 that the shieling part 2 includes and the transmittance in a case where none of the filters 24 are set in the position on the optical path P (i.e., transmittance “100%”). The user selects, from the list of transmittances displayed, a value that he/she wants to set as the transmittance of the shieling part 2 at the time of measurement and inputs the selected value to the first entry field 301.

In the second entry field 302, a list of selectable values as the transmittance of the shieling part 2 during standby is displayed, for example, in the form of a pull-down menu. The selectable transmittances here are specifically the respective transmittances of the multiple filters 24 that the shieling part 2 includes. The user selects, from the list of transmittances displayed, a value that he/she wants to set as the transmittance of the shieling part 2 during standby and inputs the selected value to the second entry field 302.

When the user has input desired transmittances in the entry fields 301 and 302 and pressed a Set Up button 303, the rotation control unit 701 stores contents specified, and, on the basis of the contents, determines the timing and revolving speed at which the drive unit 23 rotates the second gear 22.

That is, the timing at which a standby state starts (i.e., the timing at which the spectrophotometer 100 has been powered on or the timing at which the measurement has been completed), the rotation control unit 701 allows the drive unit 23 to rotate the second gear 22 to set the filter 24 with the transmittance specified in the second entry field 302 (hereinafter, also referred to as “the standby attenuating filter 24a”) in the position on the optical path P.

In this state, as shown in FIG. 4, a portion of light emitted from the light source 1 is blocked by the standby attenuating filter 24a, and only light that has been transmitted through the standby attenuating filter 24a reaches a subsequent-stage optical element (specifically, the various optical elements 30 included in the spectrometer 3, etc.) set on the optical path P. Therefore, when it is in a standby state, wasteful deterioration of the optical elements 30 is suppressed. Meanwhile, a portion of the light emitted from the light source 1 is transmitted through the standby attenuating filter 24a, and reaches the detector 5 through the optical elements 30, etc. As will be described later, using the light that has reached the detector 5, the state determining unit 702 monitors whether or not the light source 1 and the optical elements 30 are in a stable state.

Furthermore, at the timing at which the measurement starts, the rotation control unit 701 causes the drive unit 23 to rotate the second gear 22 to set the filter 24 with the transmittance specified in the first entry field 301 (hereinafter, also referred to as “the measurement attenuating filter 24b”) in the position on the optical path P. However, in a case where the transmittance specified in the first entry field 301 is “100%”, all the filters 24 are set in the position deviated from the optical path P.

In a case where a value smaller than 100% is specified as the transmittance of the shieling part 2 at the time of measurement, the measurement attenuating filter 24b is set in the position on the optical path P as shown in FIG. 5. In this state, a portion of light emitted from the light source 1 is blocked by the measurement attenuating filter 24b, and only light that has been transmitted through the measurement attenuating filter 24b reaches the subsequent-stage optical elements 30 set on the optical path P. Therefore, during the measurement is carried out, deterioration of the optical elements 30 is suppressed. Meanwhile, a portion of the light emitted from the light source 1 is transmitted through the measurement attenuating filter 24b, and is transmitted through the optical elements 30 and the sample in the sample cell 40 sequentially, and then reaches the detector 5. The detector 5 detects the received light, and the controller/processor 11 identifies the transmittance, reflectance, or absorbance, etc. of the sample on the basis of a detection signal obtained from the detector 5.

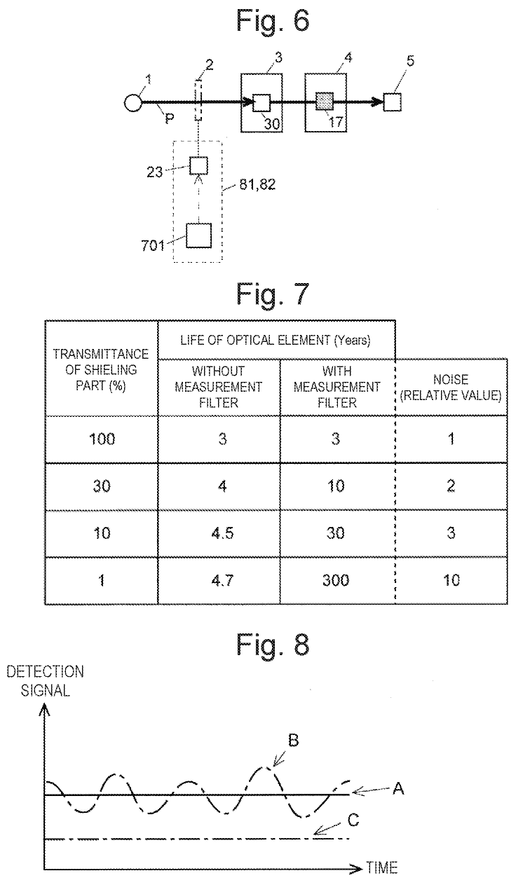

On the other hand, in a case where 100% is specified as the transmittance of the shieling part 2 at the time of measurement, all the filters 24 are set in the position deviated from the optical path P as shown in FIG. 6. In this state, all of light emitted from the light source 1 is transmitted through the optical elements 30 and the sample in the sample cell 40 sequentially, and reaches the detector 5. The detector 5 detects the received light, and the controller/processor 11 identifies the transmittance, reflectance, or absorbance, etc. of the sample on the basis of a detection signal obtained from the detector 5. In this case, although it is not possible to suppress deterioration of the optical elements 30 during the measurement is carried out, it is possible to carry out the measurement by exposing the sample cell 40 to a sufficient amount of light, and therefore, noise in a measurement result is reduced.

FIG. 7 shows a table of how a life of an optical element and noise (the amount of noise) of a detection signal of the detector 5 at the time of measurement change depending on the transmittance of the shieling part 2 in a case where a portion of light emitted from the light source 1 is blocked by the filter 24. However, in this table, “life of optical element” is based on a case where light emitted from the light source 1 is not blocked at all both at the time of measurement and during standby. Furthermore, “noise” is expressed in the ratio (the noise ratio), where noise in the case where light emitted from the light source 1 is not blocked at all both at the time of measurement and during standby is “1”.

As can be seen from this table, for example, in a case where one having a transmittance of 30% is selected as the standby attenuating filter 24a, and any filters 24 are not set in the position on the optical path P at the time of measurement (i.e., the transmittance of the shieling part 2 at the time of measurement is set to 100%), it can be seen that the life of the optical element 30 is extended from three years to four years.

Furthermore, for example, in a case where ones having a transmittance of 30% are selected as the standby attenuating filter 24a and the measurement attenuating filter 24b, it can be seen that the life of the optical element is greatly extended from three years to ten years. In this case, however, noise at the time of measurement increases twofold. Therefore, for example, in a case where the allowable noise amount at the time of measurement is relatively large, it may be said that such a selection is effective.

### 3. Configuration Related to State Determination

As described above, in the spectrophotometer 100, even in a standby state, a portion of the light emitted from the light source 1 is transmitted through the standby attenuating filter 24a, and reaches the detector 5 (FIG. 4). The detector 5 detects the received light, and transmits a detection signal to the state determining unit 702. The state determining unit 702 determines whether or not the light source 1 and an optical element (specifically, the various optical elements 30 included in the spectrometer 3, etc.) are in a stable state on the basis of the detection signal obtained from the detector 5 (specifically, the transition of detection signals).

An aspect of the determination by the state determining unit 702 is specifically described with reference to FIG. 8. FIG. 8 is a diagram schematically showing an example of the transition of detection signals obtained from the detector 5 during standby.

The transition of detection signals obtained from the detector 5 indicates the transition of the amount of light that has reached the detector 5; for example, for a while after the light source 1 is turned on, the amount of light emitted from the light source 1 is not stable. In this state, the amount of light that has reached the detector 5 is not stable (transition B). Furthermore, for example, when the temperature of an internal space of the spectrophotometer 100 has increased due to heat generated by the light source 1 or something, respective temperatures of an optical element 30, a member that supports the optical element 30, etc. increase in accordance with the temperature rise of their surrounding space; while this temperature change is taking place, the optical element 30 is slightly moving, and an optical path is not stable. In such a state, the optical path deviates from an intended position, and therefore, an intended amount of light does not reach the detector 5 (transition C).

Accordingly, the state determining unit 702 monitors the transition of the amount of light detected by the detector 5, and determines whether or not it is in a state in which the predetermined amount of light has reached the detector 5 stably (transition A), if positive determination is obtained here, it is determined that both the light source 1 and the optical elements 30 are in a stable state.

In this way, in this embodiment, the detector 5 and the state determining unit 702 work together and serve as a state monitoring unit 83 (FIG. 4) that monitors whether or not the light source 1 and the optical elements 30 are in a stable state by monitoring light that has been transmitted through the filter 24 on the side of a stage subsequent to the optical elements 30.

### 4. Flow of Operation of Spectrophotometer

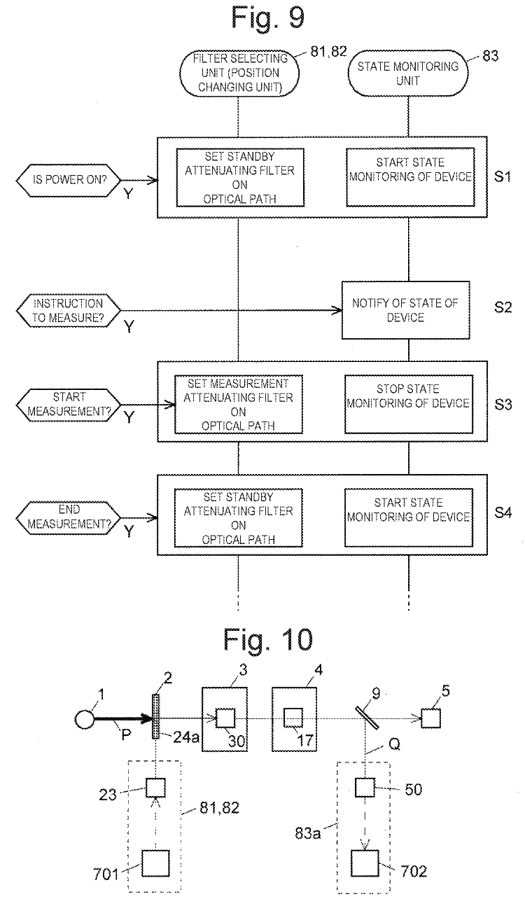

Subsequently, the flow of the operation of the spectrophotometer 100 is described with reference to FIGS. 4 to 6 and 9. FIG. 9 is a diagram for describing the flow.

When the spectrophotometer 100 has been powered on, the light source 1 is turned on. Along with this, the filter selecting unit 81 sets the standby attenuating filter 24a in the position on the optical path P (FIG. 4). Furthermore, the state monitoring unit 83 starts monitoring light that has been transmitted through the standby attenuating filter 24a and reached the detector 5, and starts monitoring whether or not the light source 1 and the optical elements 30 are in a stable state (Step S1). The monitoring by the state monitoring unit 83 continues until a measurement starts.

When the user has issued an instruction to start a measurement through the operation unit 71, the state monitoring unit 83 notifies the measurement control unit 700 of information of whether or not the light source 1 and the optical elements 30 are in a stable state (Step S2).

If the measurement control unit 700 has been notified of information that the light source 1 or the optical elements 30 are not in a stable state by the state monitoring unit 83, the measurement control unit 700 notifies the user of the information, for example, through a screen display on the display unit 72. It is often the case that for a while (about one hour) after the light source 1 is turned on, the light source 1 or the optical elements 30 are not in a stable state, and if the user has issued an instruction to start a measurement in such a period of time, it is highly likely that the measurement will not be started.

On the other hand, if the measurement control unit 700 has been notified of information that the light source 1 and the optical elements 30 are in a stable state by the state monitoring unit 83, the measurement control unit 700 gives each unit of the spectrophotometer 100 an instruction to start a measurement.

Here, when it is in a standby state, the state monitoring unit 83 monitors whether or not the light source 1 and the optical elements 30 are in a stable state; therefore, when an instruction to start a measurement has been received from the user, whether or not they are in a stable state (i.e., whether or not the spectrophotometer 100 is in a fit state to measure) is confirmed immediately. Therefore, there is no time lag between when the instruction to start a measurement has been issued from the user and when the measurement is actually started.

When having received the instruction to start a measurement from the measurement control unit 700, the filter selecting unit 81 sets the measurement attenuating filter 24b in the position on the optical path P, instead of the filter to the standby attenuating filter 24a (FIG. 5). In a case where the transmittance at the time of measurement is specified to be 100%, the position changing unit 82 sets all the filters 24 in the position deviated from the optical path P (FIG. 6). Furthermore, when having received the instruction to start a measurement from the measurement control unit 700, the state monitoring unit 83 temporarily stops monitoring whether or not the light source 1 and the optical elements are in a stable state (Step S3).

Meanwhile, in accordance with the instruction to start a measurement from the measurement control unit 700, a sample is flown into the sample cell 40. Therefore, light that has been emitted from the light source 1 and then has reached the spectrometer 3 through the measurement attenuating filter 24b (or without any filter 24) is made into monochromatic light, and enters the sample cell 40, and is transmitted through the sample in the sample cell 40, and then reaches the detector 5. The detector 5 detects the received light, and the controller/processor 11 identifies the transmittance, reflectance, or absorbance, etc. of the sample on the basis of a detection signal obtained from the detector 5.

When the measurement is completed, the filter selecting unit 81 sets the filter to the standby attenuating filter 24a in the position on the optical path P (FIG. 4). Furthermore, the state monitoring unit 83 temporarily starts monitoring light that has reached the detector 5 through the standby attenuating filter 24a, and resumes monitoring whether or not the light source 1 and the optical elements 30 are in a stable state (Step S4).

### 5. Modification Example

In the above-described embodiment, the state determining unit 702 determines whether or not the light source 1 and the optical elements 30 are in a stable state on the basis of a detection signal obtained from the detector 5, and the detector 5 and the state determining unit 702 configure the state monitoring unit 83; however, the configuration of the state monitoring unit 83 is not limited to this.

For example, as shown in FIG. 10, for example, a beam splitter (or a mirror) 9 is configured to be set on an optical path between the optical elements 30 and the detector 5 when it is in a standby state. Then, a detector 50 for state determination is set on an optical path Q of light guided in a direction different from the detector 5 through the mirror 9. According to this configuration, when it is in a standby state, all (or a portion) of light that has been emitted from the light source 1 and transmitted through the optical elements 30 is detected by the detector 50 for state determination. Then, the state determining unit 702 determines whether or not the light source 1 and the optical elements 30 are in a stable state on the basis of the transition of detection signals obtained from the detector 50 for state determination.

According to this modification example, the detector 50 for state determination the state determining unit 702 work together and serve as a state monitoring unit 83a.

In the above-described embodiment, the shieling part 2 includes the multiple filters 24 with different transmittances; however, the shieling part 2 may include only one filter 24.

In the above-described embodiment, the drive unit 23 and the rotation control unit 701 work together and move the filters 24; however, the mechanism for movement is not indispensable; for example, the user may move the filters 24 by hand.

In the above-described embodiment, the filters 24 are made of wire mesh; however, the filters 24 do not always have to be made of wire mesh, and may be made of, for example, an optical filter.

In the above-described embodiment, the light source 1 does not always have to be a deuterium lamp, and may be, for example, a halogen lamp, a xenon lamp, a xenon flash lamp, or the like. Furthermore, two or more types of lamps may be provided, and one of the lamps may be selected depending on a use condition (a wavelength range necessary for measurement) and used as the light source 1.

In the above-described embodiment, there is described the case where the present invention is applied to the spectrophotometer 100, however, the present invention can also be applied to photometers (for example, a photometer including no spectrometer 3) other than the spectrophotometer 100.

### REFERENCE SIGNS LIST

100 . . . Spectrophotometer
1 . . . Light Source
2 . . . Shieling Part
20 . . . Window Portion
21 . . . First Gear
22 . . . Second Gear
23 . . . Drive Unit
24 . . . Filter
24a . . . Standby Attenuating Filter
24b . . . Measurement Attenuating Filter
3 . . . Spectrometer
30 . . . Optical Element
4 . . . Sample Chamber
40 . . . Sample Cell
5 . . . Detector
6 . . . Signal Processing Unit
7 . . . Control Unit
70 . . . Storage Unit
71 . . . Operation Unit
72 . . . Display Unit
700 . . . Measurement Control Unit
701 . . . Rotation Control Unit
702 . . . State Determining Unit
81 . . . Filter Selecting Unit
82 . . . Position Changing Unit
83, 83a . . . State Monitoring Unit

1. An analysis apparatus that includes a light source, an optical element disposed on an optical path of light emitted from the light source, and a detector, the photometer comprising:
an attenuating filter that is disposed on the optical path and between the light source and the optical element, and blocks a portion of the light emitted from the light source and allows a rest of the light to be transmitted through the attenuating filter; and
a state monitoring unit that monitors whether or not the light source and the optical element are in a stable state by continuously monitoring light that has been transmitted through the attenuating filter on a side of a stage subsequent to the optical element during a standby state.

2. The analysis apparatus according to claim 1, further comprising a position changing unit that causes the attenuating filter to move between a position on the optical path of the light emitted from the light source and a position deviated from the optical path.

3. The analysis apparatus according to claim 1, further comprising:
a plurality of filters with different transmittances; and
an attenuating filter selecting unit that sets, as the attenuating filter, one filter selected from the plurality of filters in a position on the optical path.

4. The analysis apparatus according to claim 1, wherein the state monitoring unit monitors whether or not the light source and the optical element are in a stable state by monitoring an amount of light detected by the detector.
